(19) United States
(12) Patent Application Publication
(10) Pub. No.: US 2025/0172433 A1
(43) Pub. Date: May 29, 2025

(54) LUMINESCENCE SPECTROSCOPY APPARATUS

(71) Applicants: PRESIDENT AND FELLOWS OF HARVARD COLLEGE, Cambridge, MA (US); ECOLE POLYTECHNIQUE FEDERALE DE LAUSANNE (EPFL), Lausanne (CH)

(72) Inventors: Sascha FELDMANN, Lausanne (CH); Antti-Pekka M. Reponen, Turku (FI); Marcel Mattes, Lausanne (CH)

(73) Assignees: PRESIDENT AND FELLOWS OF HARVARD COLLEGE, Cambridge, MA (US); ECOLE POLYTECHNIQUE FEDERALE DE LAUSANNE (EPFL), Lausanne (CH)

(21) Appl. No.: 18/960,271

(22) Filed: Nov. 26, 2024

Related U.S. Application Data
(60) Provisional application No. 63/602,804, filed on Nov. 27, 2023.

(51) Int. Cl. G01J 3/44; G01J 3/02; G01J 3/10; G01J 3/12; G01J 3/28; G01N 21/64

(52) U.S. Cl. CPC G01J 3/4406; G01J 3/0202; G01J 3/10; G01J 3/2803; G01J 3/2823; G01N 21/6408; G01N 21/6456; G01J 2003/1291; G01J 2003/282

(57) ABSTRACT

A luminescence spectroscopy apparatus for time-resolved characterization of a sample emitting circularly polarized light is described, comprising a pulsed laser excitation source configured to generate a laser pulse for exciting the sample, an achromatic quarter-wave plate arranged to receive therethrough light emitted by the sample, a polarization beam splitter arranged downstream to the quarter-wave plate, an optical spectrometer arranged downstream to the polarization beam splitter, a time-gated intensified charge-coupled device arranged to receive light from the optical spectrometer and comprising an image intensifier, and a controller configured to control a pulse generator to apply a gate pulse to the image intensifier for selectively activating the image intensifier, wherein the controller is connected to the pulsed laser excitation source such that the gate pulse is triggerable by the laser pulse of the pulsed laser excitation source.

### FIELD OF THE INVENTION

The present invention relates to a luminescence spectroscopy apparatus for time-resolved characterization of a sample emitting circularly polarized light and a method of time-resolved characterization of a sample emitting circularly polarized light.

### BACKGROUND OF THE INVENTION

Circularly polarized luminescence (CPL)-emitting materials have experienced an increase in research interest over recent years, largely driven by emerging and commercially promising technologies. Applications may utilize CPL-emitting materials in photonics and spin-optoelectronics, spanning a broad range from photonic and quantum computing, security inks, efficient displays, as well as biomedical imaging, holographic and 3D display technologies.

Accordingly, there is a great interest in accurate characterization of circularly polarized light emission processes. However, methodologies for measuring and investigating CPL-active materials are largely unchanged since the late 20th century. Schemes for time-resolved CPL (TRCPL) measurements are only rarely described due to the difficulty of CPL measurements arising from typically low signals and prominent artifacts.

For example, TRCPL has been attempted by using a photoelastic modulator (PEM) for rapid polarization modulation, followed by lock-in amplification or differential photon counting, as described by J. A. Schauerte et al., Proc. Natl. Acad. Sci. USA 1995, 92, 569-573. In practice, combining PEM modulation with time resolution has strong limitations. The modulation rate must be compatible with detector readout rate, excitation repetition rate, and luminescence timescales. As the detection scheme is not broadband, spectra must be built up one wavelength point at a time. Even in the steady state, full spectrum acquisition is time-consuming. With time-correlated single photon counting additionally dividing emission into multiple time bins and limiting collected count rates to ˜1% of the excitation rate to avoid pile-up, time-resolved CPL spectra become impractical. As time-dependent spectral evolution is common, kinetics obtained at a single wavelength or without any wavelength resolution provide only limited insights into excited-state evolution.

### SUMMARY OF THE INVENTION

It is therefore an object of the invention to provide a luminescence spectroscopy apparatus for time-resolved characterization of a sample emitting circularly polarized light and a method of time-resolved characterization of a sample emitting circularly polarized light which at least partially improve the prior art and avoid at least part of the disadvantages of the prior art.

According to the present invention, this object is achieved by the features of the independent claims. In addition, further advantageous embodiments follow from the dependent claims and the description as well as the figures.

According to an aspect of the invention, this object is particularly achieved by a luminescence spectroscopy apparatus for time-resolved characterization of a sample emitting circularly polarized light, comprising a pulsed laser excitation source configured to generate a laser pulse for exciting the sample, an achromatic quarter-wave plate arranged to receive therethrough light emitted by the sample, a polarization beam splitter arranged downstream to the quarter-wave plate, an optical spectrometer arranged downstream to the polarization beam splitter, a time-gated intensified charge-coupled device arranged to receive light from the optical spectrometer and comprising an image intensifier, and a controller configured to control a pulse generator to apply a gate pulse to the image intensifier for selectively activating the image intensifier, wherein the controller is connected to the pulsed laser excitation source such that the gate pulse is triggerable by the laser pulse of the pulsed laser excitation source.

Using a pulsed laser excitation source and a time-gated intensified charge-coupled device (iCCD), time-resolved measurements can be enabled. In particular, by using a CCD, setup cost and complexity can be reduced. Compared to time-correlated single photon counting based methods, the iCCD detector is not limited by pile-up effects, allowing for much higher data acquisition rate, with photon counts only limited by sample emissivity and detector overexposure.

Electronically gating the iCCD detector using the controller and the pulse generator advantageously allows for flexible time gating, for example with gate widths from 2 ns to multiple ms. As photons may be collected over a specific time range, as defined by the gate pulse with a given gate delay and gate width, emission features which may dominate the steady-state spectrum can temporally be separated out. Using a short gate with small delay and width, intense and fast decay components can be collected. Using a long gate with large delay and width, weak and slow decay components can be collected without being hampered by detector saturation due to fast decay components. Thus, multiple emission time scales can be spanned for TRCPL measurements, providing high-sensitivity CPL measurements of emission pathways which would be overwhelmed by higher-intensity pathways in other detection schemes, while allowing fast measurements without being limited by photon pile-up effects.

The controller may be a joint controller for the luminescence spectroscopy apparatus or comprise one more or sub-controllers for one or more of the components of the luminescence spectroscopy apparatus such as for example the pulsed laser excitation source, the iCCD detector, the pulse generator, the motor controllers, the spectrometer etc. The pulse generator may be a separate pulse generator external to the iCCD detector or realized by timing electronics integrated into the iCCD detector.

Using an achromatic quarter-wave plate, broadband measurements spanning most of the visible range in a single acquisition can be provided. Orthogonal polarizations of the light emitted by the sample can spatially be separated by the polarization beam splitter receiving the light passed through the quarter-wave plate. Specifically, circularly polarized light emitted by the sample can be converted to linearly polarized light by the quarter-wave plate. The linear polarization components can then spatially be separated by the polarization beam splitter and simultaneously recorded as two separate tracks by the iCCD detector.

In the present context, the term “downstream” shall be understood with respect to the propagation direction of the light. For example, a second optical component arranged downstream to a first optical component receives the light from the first optical component.

In some embodiments, the polarization beam splitter is a birefringent polarization beam splitter.

Using a birefringent polarization beam splitter provides, in particular, the advantage of a high extinction ratio and broadband capability.

In particular, the birefringent beam splitter may be a Wollaston polarizer or a Rochon polarizer.

Using a Wollaston polarizer or a Rochon polarizer provides the advantage that the orthogonal polarizations of the light emitted by the sample and being passed through the quarter-wave plate can spatially be separated with a sufficiently small separation of the polarization components or ordinary and extraordinary rays, respectively, such that the separated rays continue to propagate substantially along the direction of propagation of the light as emitted by the sample. Therefore, a free-space setup without fiber coupling or mirrors between the sample and the spectrometer can be achieved.

Using a Wollaston polarizer, in particular, a sufficient spatial separation between the orthogonal polarization can be reached for a distinct acquisition of the polarization tracks at the iCCD detector while keeping the deviations between the polarization components sufficiently small to enable a compact design of the luminescence spectroscopy apparatus. In particular, the compactness as enabled by the Wollaston polarizer contributes to the luminescence spectroscopy apparatus being able to be realized on a single chip, while ensuring effective separation and acquisition of the orthogonal polarization components.

The polarization beam splitter may also be another polarizer such as for example a Glan-Thompson polarizing prism, a Foster polarizing beam splitter, a Glan polarizing prism, a polarizing beam splitter cube, a Savart plate, a polarization beam splitter plate, etc.

In some embodiments, the luminescence spectroscopy apparatus comprises an achromatic half-wave plate arranged in sequence with the quarter-wave plate.

Using the half-wave plate, linear polarization components can be quantified in addition. In particular, adding the half-wave plate allows for a complete characterization of the polarization state. By executing a set of measurements using combinations of different quarter-wave plate and half-wave plate orientations, time-resolved broadband measurement of the full Stokes vector can therefore be provided. At suitable angle combinations, only a specific Stokes component can be made to contribute to intensity differences between the tracks as recorded by the iCCD detector. In particular, the magnitude of linear emission components due to photoselection may be accounted for and isolated from the intrinsic CPL magnitude of the emitting sample.

In some embodiments, the quarter-wave plate is arranged downstream to the half-wave plate.

Alternatively, the half-wave plate may be arranged downstream to the quarter-wave plate.

In some embodiments, the charge-coupled device comprises an image area with a first region of interest configured to receive light with a first polarization component and a second region of interest configured to receive light with a second polarization component.

The luminescence spectroscopy can therefore be executed using a single CCD detector since the orthogonally polarized spectra can be recorded simultaneously as two tracks on the single CCD detector by means of the different regions of interest defined on the CCD pixel array. Using a single CCD detector provides the advantage that issues with detector synchronization, as experienced with measurements using two detectors, can be eliminated. Furthermore, the electronic timing issues when collecting the tracks of different polarization components can be avoided since the tracks are recorded on the same CCD detector.

In some embodiments, the luminescence spectroscopy apparatus comprises a first motor controller, wherein the quarter-wave plate is rotatably mounted in a motorized rotary mount, wherein the first motor controller is configured to control rotation of the quarter-wave plate.

Rotation of the quarter-wave plate enables to implement an error cancellation scheme, as described hereinafter in further detail. By executing e.g. a luminescence measurement with the quarter-wave plate having its fast axis at 45° with respect to the horizontal and repeating the measurement with the quarter-wave plate having its fast axis rotated by 90° with respect to the first measurement, the polarization components imaged on a given track can be swapped. By averaging the measurements repeated with the different quarter-wave plate orientations, intensity variations arising from imperfect channel transmittance matching and/or time instability errors can be cancelled out. The motorized rotary mount of the quarter-wave plate and the first motor controller provide the advantage that the rotations of the quarter-wave plate can be executed in a highly precise and reproducible fashion. Furthermore, the error cancellation scheme involving the rotation of the quarter-wave plate can be automatized using a controller, such as a personal computer, interfacing the first motor controller.

In some embodiments, the luminescence spectroscopy apparatus comprises a second motor controller, wherein the half-wave plate is rotatably mounted in a motorized rotary mount, wherein the second motor controller is configured to control the rotation of the half-wave plate.

By rotating the half-wave plate, an error cancellation scheme involving the linearly polarized components can be implemented, similar to the error cancellation scheme as described with regard to the quarter-wave plate. By executing e.g. a luminescence measurement with the half-wave plate having its fast axis at 0° with respect to the horizontal and repeating the measurement with the half-wave plate having its fast axis rotated by 45° with respect to the first measurement, the polarization components imaged on a given track can be swapped. The motorized rotary mount of the half-wave plate and the second motor controller provide the advantage that the rotations of the half-wave plate can be executed in a highly precise and reproducible fashion. Furthermore, the error cancellation scheme involving the rotation of the half-wave plate can be automatized using a controller, such as a personal computer, interfacing the second motor controller.

Thus, the wave plates can be used to make the polarization components of interest (e.g. 0°/90°, +45°/−45°, left-handed circular polarization (LCP)/right-handed circular polarization (RCP)) fall to the horizontal or vertical tracks, and then use another waveplate orientation to swap the components on the tracks. The swapping of tracks, combined with measuring both tracks at two such waveplate orientations, advantageously allows for cancelling out the bulk of errors caused by any transmission inequalities between the two beam paths. Further, by simultaneously recording both tracks, the bulk of time-instability errors, arising from e.g. drift in excitation intensity, can be cancelled out.

In some embodiments, the quarter-wave plate and the polarization beam splitter define a detection path downstream of the sample, wherein the pulsed laser excitation source is configured to define an excitation path which is perpendicular to the detection path.

The excitation path along which the excitation laser pulse propagates and the detection path along which the light emitted by the sample propagates may therefore be arranged in an orthogonal geometry. The orthogonal geometry provides the advantage that the light of the excitation laser pulse is less likely to leak into the detection path.

In some embodiments, the pulsed laser excitation source comprises excitation optics configured to define the excitation path.

In some embodiments, the pulsed laser excitation source is configured to generate a laser pulse having a horizontal polarization.

Generating the excitation laser pulse with a horizontal polarization is, in particular, advantageous for the excitation path being perpendicular to the detection path since photoselection effects can be minimized in the orthogonal geometry. Photoselection effects can especially be relevant in CPL measurements due to their sensitivity to linear anisotropy-induced artefacts since photoselection is a common source of linear anisotropy in otherwise isotropic samples. By exciting the sample with horizontally polarized light in an orthogonal geometry, light in the detection path without preferential polarization arising from photoselection may be obtained.

In some embodiments, the quarter-wave plate and the polarization beam splitter define a detection path downstream of the sample, wherein the pulsed laser excitation source is configured to define an excitation path which is parallel to the detection path.

For solid samples such as films or crystals, it may be advantageous to arrange the pulsed laser excitation source such that the excitation path is parallel to the detection path due to the reflection properties of the excitation light from the sample. For example, partial reflection of excitation light from the sample into the detector may lead to increased complexity of the detected signal in an orthogonal geometry, while in a parallel geometry, partially reflected light may be reflected back into the excitation source.

Arranging the pulsed laser excitation source such that the excitation path is parallel to the detection path may furthermore be advantageous for thin samples.

According to a further aspect, the invention is also directed to a method of time-resolved characterization of a sample emitting circularly polarized light, comprising the steps of: a) providing a luminescence spectroscopy apparatus according to the present disclosure; b) generating by the pulsed laser excitation source a laser pulse for exciting a sample; c) receiving by the controller a trigger signal from the pulsed laser excitation source; d) triggering the pulse generator by the controller to generate a gate pulse; e) activating the image intensifier by applying the gate pulse by the pulse generator to the image intensifier; f) recording simultaneously a first polarization component of light emitted by the sample on a first region of interest of an image area of the charge-coupled device and a second component of light emitted by the sample on a second region of interest of the image area of the charge-coupled device.

The intensified charge-coupled device can therefore be time-gated using the trigger signal from the pulsed laser excitation source upon which a gate pulse for activating the intensifier is generated and applied by the pulse generator. The polarization components can simultaneously be recorded by the first and second regions of interest on the image area of the CCD detector. As described above, highly sensitive time-resolved CPL measurements can be provided in this fashion.

In some embodiments, the method comprises the steps of: executing the steps of b)-f) at a first orientation of the quarter-wave plate with its fast axis being at a first quarter-wave plate angle; rotating the quarter-wave plate by a first motor controller to a second orientation with the fast axis being at a second quarter-wave plate angle, wherein the first quarter-wave plate angle and the second quarter-wave plate angle differ by 90°; repeating the steps of b)-e), and recording the first polarization component of light emitted by the sample on the second region of interest of the image area of the charge-coupled device and the second component of light emitted by the sample on the first region of interest of the image area of the charge-coupled device.

By rotating the quarter-wave plate after a first measurement in this fashion, the orthogonal circularly polarized components of a given track can be swapped, providing an error cancellation scheme, as described above and in connection with the Figures. After swapping of the circular polarization components, the first polarization component can therefore be recorded by the second region of interest of the image area of the CCD detector. Likewise, the second polarization component can be recorded by the first region of interest of the image area of the CCD detector after swapping of the polarization components.

In some embodiments, after rotating the quarter-wave plate by the first motor controller to the second orientation, beam steering is executed on the pulsed laser excitation source until the light from the pulsed laser excitation source is collected by the same pixels of the charge-coupled device as before rotation of the quarter-wave plate.

Rotation of the quarter-wave plate may introduce a slight deflection of the beam generating a beam drift effect hampering the track-swapping pixel sensitivity correction. By executing beam steering after the quarter-wave plate rotation such that the same pixels are used to collect the light in the measurements before and after the quarter-wave plate rotation, static noise due to the beam drift can be corrected for. In particular, the excitation beam may be steered using a steering mirror arranged before the sample. The excitation beam may be steered vertically after the quarter-wave plate rotation such that a vertical displacement of the spectral traces on the CCD due to beam drift is reversed. The CCD detector may have a live imaging readout in order to facilitate the realignment of the displaced spectral traces by steering the excitation beam.

In some embodiments, the method comprises the steps of: rotating the quarter-wave plate by the first motor controller to a third orientation with the fast axis being at a third quarter-wave plate angle, wherein the second quarter-wave plate angle and the third quarter-wave plate angle differ by 90°; repeating the steps of b)-f).

In some embodiments, the method comprises the steps of: rotating the quarter-wave plate by the first motor controller to a fourth orientation with the fast axis being at a fourth quarter-wave plate angle, wherein the third quarter-wave plate angle and the fourth quarter-wave plate angle differ by 90°; repeating the steps of b)-e); recording the first polarization component of light emitted by the sample on the second region of interest of the image area of the charge-coupled device and the second component of light emitted by the sample on the first region of interest of the image area of the charge-coupled device.

Beam drift effects can furthermore be mitigated by executing measurements with more than two quarter-wave plate orientations. For the CPL measurements using the quarter-wave plate, a total of four different orientations may be used, each orientation differing by 90° from the antecedent orientation. By using multiple orientations, the beam drift due to deflections of the beam introduced by rotation of the quarter-wave plate may be reduced since the beam drift may at least partially be reversed upon further rotation of the waveplate, a total rotation of 360° returning the beam to its initial position.

In some embodiments, the method comprises the steps of: providing in step a) an achromatic half-wave plate arranged in sequence with the quarter-wave plate; executing the steps of b)-f) at a first orientation of the half-wave plate with its fast axis being at a first half-wave plate angle; rotating the half-wave plate by a second motor controller to a second orientation with the fast axis being at a second half-wave plate angle, wherein the first half-wave plate angle and the second half-wave plate second angle differ by 45°; repeating the steps of b)-e), and recording the first polarization component of light emitted by the sample on the second region of interest of the image area of the charge-coupled device and the second component of light emitted by the sample on the first region of interest of the image area of the charge-coupled device.

By rotating the half-wave plate after a first measurement in this fashion, the orthogonal linearly polarized components of a given track can be swapped, providing an error cancellation scheme, as described above and in connection with the Figures. After swapping of the linear polarization components, the first polarization component can therefore be recorded by the second region of interest of the image area of the CCD detector. Likewise, the second polarization component can be recorded by the first region of interest of the image area of the CCD detector after swapping of the polarization components.

Similar to the quarter-wave plate described above, beam drift effects may be mitigated by repeating the measurements with more than two different orientations of the half-wave plate. For the half-wave plate, a total of eight different orientations may be used, each orientation differing by 45° from the antecedent orientation.

In some embodiments, after rotating the half-wave plate by the second motor controller to the second orientation, beam steering is executed on the pulsed laser excitation source until the light from the pulsed laser excitation source is collected by the same pixels of the charge-coupled device as before rotation of the half-wave plate.

Similar to as described above for the quarter-wave plate, beam steering may be used to correct for beam drift effects due to small deflections introduced by rotation of the half-wave plate.

In some embodiments, vertical pixel binning is executed in step f) such that only a first track of the first polarization component and a second track of the second polarization component is output from the charge-coupled device.

By using vertical pixel binning, detector readout rate of the CCD can be increased compared to a full-sensor readout. Furthermore, detector sensitivity and the signal-to-noise ration may be improved by vertical pixel binning.

In some embodiments, the steps b)-f) are repeated by incrementally changing a position of a grating of the optical spectrometer after each step f).

Thus, a scanning multichannel approach can be applied by incrementally offsetting the grating positions for each recording step instead of executing a single series of recording at a given grating position. By using the scanning multichannel approach, pixel noise can be mitigated.

Furthermore, sensitivity variations of the iCCD may be smoothed out.

According to a further aspect, a computer program product program code for time-resolved comprising computer characterization of a sample emitting circularly polarized light using a luminescence spectroscopy apparatus according to the present disclosure is provided, the computer program code configured to control at least one processor or circuit of the controller such that the at least one processor or circuit executes one or more steps of the method of time-resolved characterization of a sample emitting circularly polarized light according to the present disclosure.

According to a further aspect, a non-transitory computer-readable medium is provided, having stored thereon the computer program product according to the present disclosure.

According to a further aspect, a computer-implemented method of time-resolved characterization of a sample emitting 41 circularly polarized light using a luminescence spectroscopy apparatus according to the present disclosure is provided, the computer-implemented method comprising at least one processor or circuit of the controller executing one or more steps of the method of time-resolved characterization of a sample emitting circularly polarized light according to the present disclosure.

### BRIEF DESCRIPTION OF THE DRAWINGS

The present invention will be explained in more detail, by way of exemplary embodiments, with reference to the schematic drawings, in which:

FIG. 1 shows a perspective view of an embodiment of a luminescence spectroscopy apparatus;

FIG. 2 shows a block diagram of an embodiment of a luminescence spectroscopy apparatus;

FIG. 3 shows an illustration of the gate pulses for time-gating;

FIG. 4 shows a simulated example illustrating combining successive measurements by waveplate rotation and simultaneous measurements by two-channel detection;

FIG. 5 shows calculated intensity differences between measurement tracks as a function of both QWP and HWP angles for the pure Stokes basis polarizations;

FIG. 6 shows steady-state and microsecond time-resolved CPL spectroscopy of the chiral standard Eu[(+)-facam]₃;

FIG. 7 shows measurements of nanosecond time-resolved non-polarized, circular and photoselection-induced linear anisotropy of Eu[(+)-facam]₃;

FIG. 8 shows enantiomer CPL comparison and time-resolved CPL for the R-enantiomer of a chiral TADF-active compound;

FIG. 9 shows broadband steady-state and time-resolved full Stokes-vector spectroscopy of a standard achiral dye in water-based solutions with low and high viscosity.

### DETAILED DESCRIPTION OF EXEMPLARY EMBODIMENTS

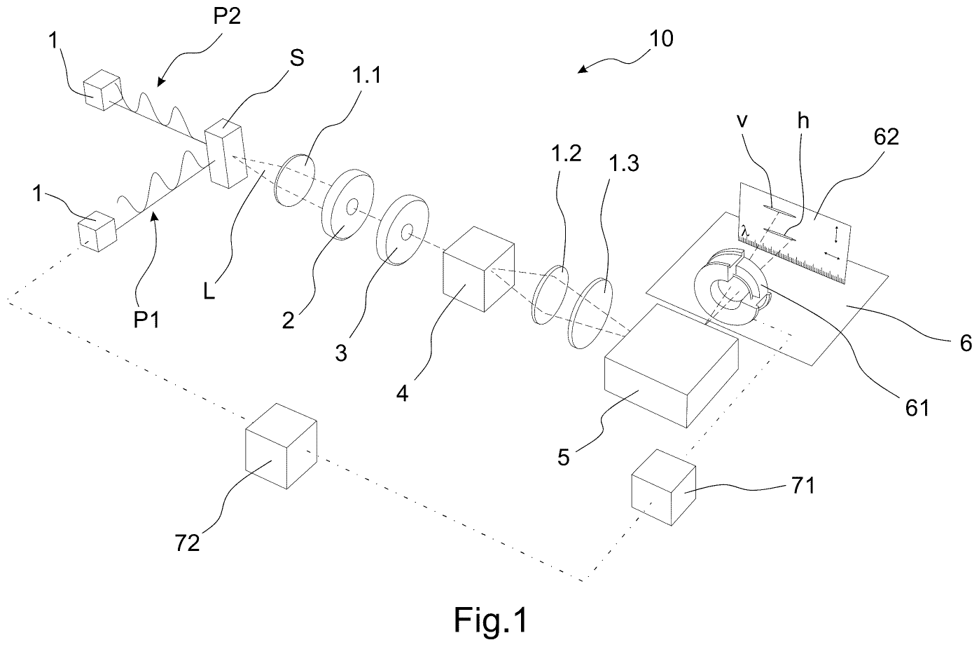

FIG. 1 shows a perspective view of an embodiment of a luminescence spectroscopy apparatus 10 comprising a pulsed laser excitation source 1. In FIG. 1, the pulsed laser excitation source 1 is shown twice in order to illustrate two configurations of the excitation path. In the first configuration realizing an orthogonal geometry, the pulsed laser excitation source 1 is arranged such that the excitation path along which the laser pulse P1 propagates is perpendicular to the detection path along which the light L emitted by the sample S propagates. In the second configuration realizing a parallel geometry, the pulsed laser excitation source 1 is arranged such that the excitation path along which the laser pulse P2 propagates is parallel to the detection path along which the light L emitted by the sample S propagates.

The laser pulse P1 or P2 excites the sample S which emits light L that propagates through a collimating lens 1.1 and reaches an achromatic half-wave plate 2 by means of which the linearly polarized components of the light L can be quantified. An achromatic quarter-wave plate 3 is arranged downstream to the half-wave plate 2 and receives the light that has passed therethrough. The half-wave plate 2 and the quarter-wave plate 3 are each rotatably arranged on a motorized rotary mount and can be rotated into appropriate orientations to transform polarization components into orthogonal linear components, which are separated by a Wollaston prism 4 arranged downstream to the quarter-wave plate 3. After passing a focusing lens 1.2 and a filter 1.3, the separated components pass through a grating spectrometer 5. The orthogonally polarized spectra are then simultaneously recorded as two tracks v and h on a single CCD array 62 of a CCD detector 6. The intensified CCD detector further comprises an intensifier 61 which is electronically gated to provide time resolution. A pulse generator 71 is configured to apply a gate pulse having a certain delay and width to the intensifier 61 upon being triggered by a controller 72. The controller 72 receives a trigger signal from the pulsed laser excitation source 1 upon generation of a laser pulse P1 or P2 for exciting the sample S.

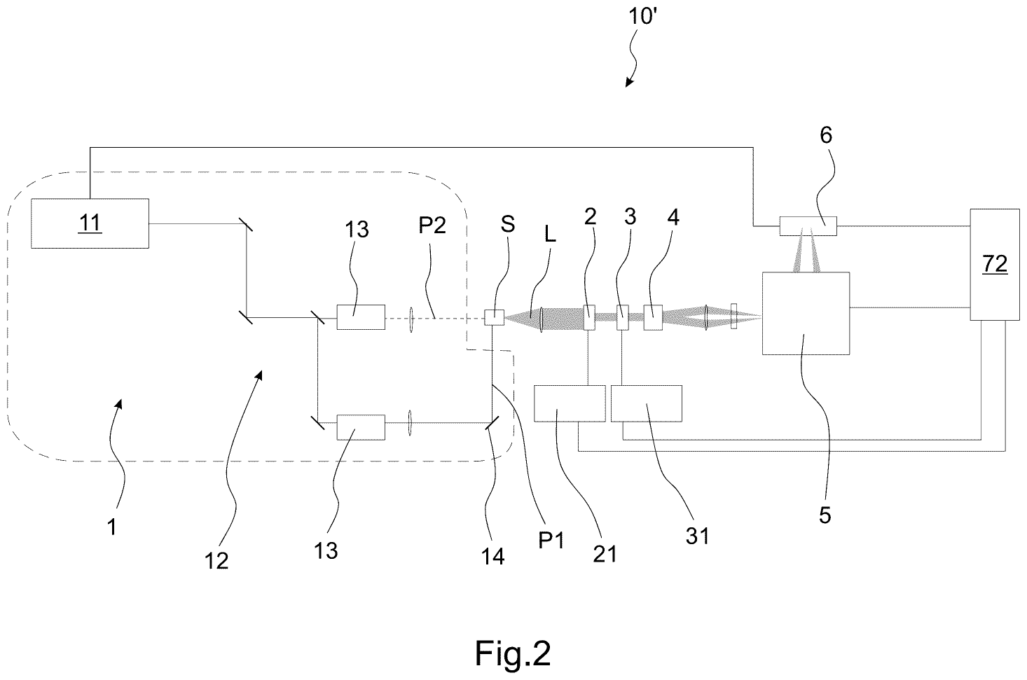

FIG. 2 shows a block diagram of an embodiment of a luminescence spectroscopy apparatus 10′. The pulsed laser excitation source 1 comprises a pulsed laser 11 and excitation optics 12 with optical components such as mirrors, lenses, filters, polarizers etc. to define the excitation beam. In particular, the excitation optics 12 comprises polarizers 13 to define the desired polarization of the excitation laser pulse. Using the excitation optics 12, the excitation path P1 or P2 can be defined. Furthermore, the excitation optics 12 comprises a steering mirror 14 by which beam steering can be executed in order to correct for beam drift effects.

The light L emitted by the source S passes through a superachromatic half-wave plate 2, a superachromatic quarter-wave plate 3 and a Wollaston prism 4 which separates the orthogonal polarization components, which then propagate to the spectrograph 5. The two polarization tracks are collected by the iCCD detector 6. The controller 72 controls the iCCD detector 6, the spectrograph and the first motor controller 31 and the second motor controller 21. The first motor controller 31 and the second motor controller 21 are used to rotate the quarter-wave plate 3 and the half-wave plate 2, respectively, which are each mounted on a motorized rotary mount. The intensifier of the iCCD detector 6 is triggered by a trigger signal from the pulsed laser 11. The controller 72 is used for simultaneous control of the components of the luminescence spectroscopy apparatus 10′ such that an automated TRCPL measurement and full Stokes measurement can be provided.

### Example Luminescence Spectroscopy Setup

In the following, an example luminescence spectroscopy setup is described.

The samples are optically excited using the output of a Light Conversion PHAROS laser (Yb:KGW lasing medium, 1030 nm, pulse energy 400 μJ, pulse width duration 200 fs, repetition rate of 50 kHz). The pump beam is generated from the seed in a harmonic generation (Light unit Conversion HIRO) via nonlinear crystals (beta-barium borate, lithium triborate) with residual fundamental removed by dichroic mirrors within the unit. Second and third harmonics can be generated, giving pump wavelengths of 515 nm or 343 nm respectively. Pump pulse energy at the sample is 10-70 nJ, with the pump focused down to a beam diameter of approximately 1 mm. The laser repetition rate is controllable by a pulse picker, and repetition rates in the range 500 Hz-50 kHz are used.

The CCD sensor has 2048×512 pixels, enabling simultaneous recording of multiple tracks. Horizontal and vertical polarization components, which are spatially separated by a Wollaston prism (shown on the sensor in Figure S2), can therefore be simultaneously recorded. Vertical pixel binning is used to produce two effective vertical pixels for each wavelength pixel, giving Iₕ(λ) and Iᵥ(λ) for the horizontal and vertical channels respectively.

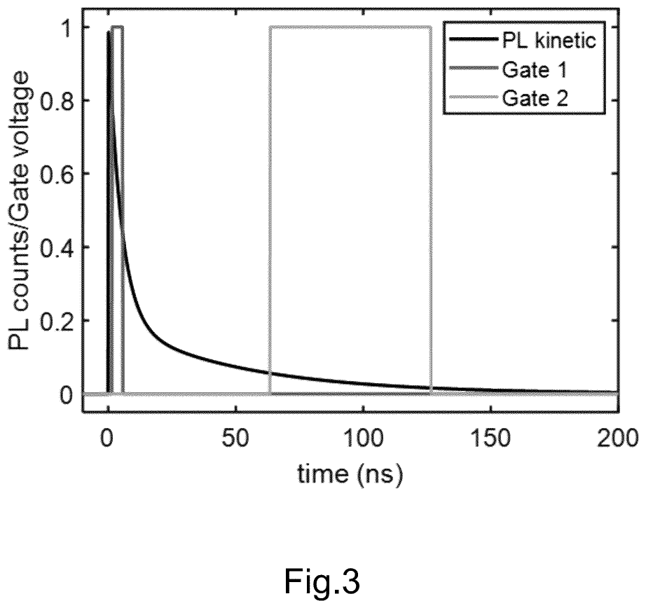

For time-resolved measurements, the quantities recorded during a single acquisition are Iₕ(λ, t) and Iᵥ(λ, t) where t is defined by the gate pulse applied, as illustrated in FIG. 3. The sample is excited by a laser pulse arriving at t=0, with the laser sync signal triggering a gate pulse on the detector with a user-defined delay and width. The detector only collects light when the gate pulse is on, resulting in collection of time-resolved spectra. Time series are built up by repeating the measurement with modified gate delays/widths.

Polarization tracks are separated from a single beam by a Wollaston prism which remains fixed. Therefore, one track will correspond to a vertical polarization and the other to a horizontal polarization. Waveplates are used to make the polarization components of interest (0°/90°, +45°/−45°, LCP/RCP) fall completely to the horizontal or vertical tracks, and then another waveplate orientation is used to swap the components on the tracks.

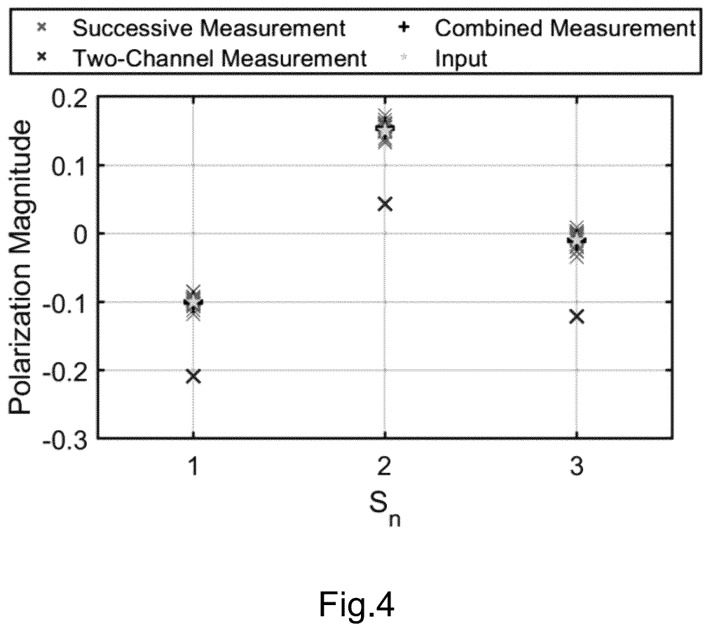

This swapping of tracks, combined with measuring both tracks at two such waveplate orientations, allows for cancelling out the bulk of errors caused by any transmission inequalities between the two beam paths. Further, the simultaneous recording of both tracks cancels out the bulk of time-instability errors, arising from e.g. drift in excitation intensity, which is illustrated in FIG. 4. FIG. 4 shows how combining successive measurements by waveplate rotation and simultaneous measurements by two-channel detection can accurately recover all Stokes components with even substantial spatial and temporal error sources. Here, track transmission mismatch has been set to 20% and a random time drift set to 5% of the incident light intensity.

After the Wollaston prism, the channels are horizontally and vertically polarized (0°/90° respectively), corresponding to the S₁ polarization axes. To investigate S₂ (linear)+45° and S₃ (LCP/RCP) polarization components, waveplates are used to transform these polarization components to 0°/90° linear polarizations. For S₂, suitable polarization transformation is achieved by a half-wave plate (HWP) at 22.5°+45°, and for S₃ with a quarter-wave plate (QWP) at 45°+90°, where the waveplate orientations are defined about the fast axis relative to the table plane. Any two adjacent orientations will swap the polarization component imaged on a given track; for example, if the RCP component is measured at the horizontal track for a 45° QWP orientation, at a 135° QWP orientation the RCP component is measured at the vertical track.

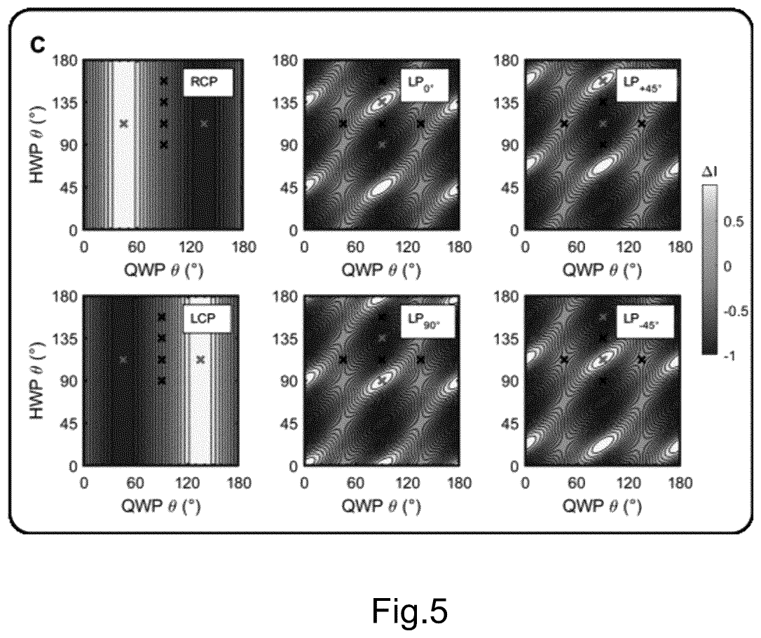

For a fast, automatable full-Stokes measurement, it is advantageous to have both waveplates in place for all measurements. An illustration of how the various Stokes components produce intensity differences between the tracks in the ideal case of perfect waveplates with both a HWP and QWP present is presented in FIG. 5. For CPL measurements, the HWP orientation in principle does not matter, but in all orientations the HWP will act to transform LCP to RCP and vice versa. The waveplate angles for measuring a given Sn component are such that the other two components are split evenly across the two channels and therefore are not measured as a false polarization signal.

As described above, two tracks are simultaneously recorded at a given orientation of the HWP and QWP. The recorded intensities are denoted as I_{v,QwPθ,HWPθ} and I_{h,QwPθ,HWPθ}.

An S₃ measurement would then seek to find I_{LCP} and I_{RCP}, recorded as

$${I}_{LCP} = {I}_{h , QWP 45 ° , HWP 0 °} + {I}_{v , QWP 135 ° , HWP 0 °}$$

$${I}_{RCP} = {I}_{v , QWP 45 ° , HWP 0 °} + {I}_{h , QWP 135 ° , HWP 0 °}$$

From which the following quantities are calculated

$$Δ I = {I}_{LCP} - {I}_{RCP}$$

$${I}_{total} = {I}_{LCP} + {I}_{RCP}$$

Whereas for an S₁ measurement one has

$${I}_{{0}^{0}} = {I}_{h , QWP 0 ° , HWP 0 °} + {I}_{v , QWP 0 ° , HWP 45 °}$$

$${I}_{{90}^{0}} = {I}_{v , QWP 0 ° , HWP 0 °} + {I}_{h , QWP 0 ° , HWP 45 °}$$

$$Δ I = {I}_{{0}^{0}} - {I}_{{90}^{0}}$$

And for an S₂ measurement

$${I}_{+ {45}^{0}} = {I}_{h , QWP 0 ° , HWP 22.5 °} + {I}_{v , QWP 0 ° , HWP 67.5 °}$$

$${I}_{- {45}^{0}} = {I}_{v , QWP 0 ° , HWP 22.5 °} + {I}_{h , QWP 0 ° , HWP 67.5 °}$$

$$Δ I = {I}_{+ {45}^{0}} - {I}_{- {45}^{0}}$$

The Stokes components are defined as

$${S}_{0} = {I}_{0 °} + {I}_{90 °} = {I}_{+ 45 °} + {I}_{- 45 °} = {I}_{LCP} + {I}_{RCP}$$

$${S}_{1} = {I}_{0 °} - {I}_{90 °}$$

$${S}_{2} = {I}_{+ 45 °} - {I}_{- 45 °}$$

$${S}_{3} = {I}_{LCP} - {I}_{RCP}$$

Since the absolute count numbers are generally not of interest, the data can be scaled for convenience such that S₀=1.

The linear polarization anisotropy (r) and circular polarization dissymmetry of the luminescence (gₗᵤₘ) are defined as

$$r = \frac{{I}_{‖} - {I}_{⊥}}{{I}_{‖} + 2 {I}_{⊥}}$$

where I_{∥} and I_{⊥} are parallel and perpendicular linearly polarized intensities, and

$${g}_{lum} = \frac{{I}_{LCP} - {I}_{RCP}}{{I}_{avg}} = \frac{{I}_{LCP} - {I}_{RCP}}{\frac{1}{2} ( {I}_{LCP} + {I}_{RCP} )}$$

Electronic gating in the example setup has a minimum gate width of approximately 2 ns, which is also the overall limit of time resolution, as the gate delay accuracy and laser pulse width are far smaller.

Maximum time range is practically limited by the laser repetition rate, as very long gate pulse values are achievable. In the example setup, the laser operates at 50 kHz and can be pulse-picked for a lower frequency operation at the same per-pulse (and lower time-averaged power).

Lower repetition rates usually lead to slower data acquisition. Presently, the practical limit to perform polarization measurements is at approximately 500 Hz, corresponding to a time range of 2 ms; extending this could be done by increasing per-pulse power at the sample. Overall, accessible time bins range from approximately 2 ns-2 ms.

For accurate quantification of gₗᵤₘ, a large number of photons at each wavelength should be counted. As a rough estimate, reaching a noise level of 10⁻⁴ requires 10⁸ photons in the ideal case where the only noise source is shot noise inherent to photon emission following Poisson statistics and signal-to-noise ratio scales with \sqrt{N} for N photons counted. In practice, this will be an underestimate for the example setup, as the intensified CCD detector has additional noise contributions compared to a photon-counting system (readout noise, shot noise in the dark signal, shot noise in the signal). It is found that measuring such a large number of photons tends to be relatively time-consuming, owing to limits on detector readout rate, laser repetition rate and detector saturation effects.

For faster measurements, the number of charges collected and read out per second is desired to be maximized. This is affected by excitation power (per pulse). Increasing the excitation laser (and thus gate pulse) repetition rate will increase signal strength, but normally it is desired to avoid wrap-around emission (i.e. emission that leaks into the photon collection after the next pulse), if possible. Beyond this, appropriate choice of time gates, exposure time and accumulations may be important. Where appropriate, pixel binning is a possible approach. For the present purposes, vertical pixels are binned such that only two tracks are recorded and read out, which greatly increases detector readout rate compared to a full-sensor readout.

Another consequence of using a multichannel detector such as a CCD is that there may be fixed pattern noise, that is, differences in count values read out by individual pixels when an identical amount of light is incident. This will be partially due to per-pixel variation of the dark signal, which will be temperature-dependent but otherwise fixed, and partially due to per-pixel variation in sensitivity due to manufacturing irregularities. The dark signal variation can be removed by background subtraction, and the per-pixel sensitivity variation, like other channel-dependent sensitivity variations, may be corrected for in the difference spectra and dissymmetry factor by the two-step measurement procedure where a QWP rotation flips the horizontal/vertical channels.

Rotation of the QWP may introduce a slight deflection of the beam. As such, the pixels which collect light in the second measurement are not exactly the same pixels as in the first measurement. Due to this, the track-swapping pixel sensitivity correction is incomplete, which may result in unexpectedly high static noise (i.e. consistent between measurements, assuming optics are not moved) approximately at the 10⁻² level. This can be corrected for by steering the excitation beam vertically after QWP rotation such that the same pixels are used to collect signal in both measurements. This can be facilitated by the detector having a live imaging readout which can be used for alignment. Beam steering or resteering, respectively, can be achieved by a steering mirror placed immediately before the sample. For the same measurement parameters, the apparent noise level is massively improved by manually resteering the beam after waveplate rotation. This is because the “noise” without beam resteering s not true statistical noise, but rather static imperfections in the error cancellation caused by changing the pixels over which data is collected.

Horizontal beam deflection (orthogonal to the spectrograph entrance slit) is largely mitigated by using a 90° excitation-collection geometry a with slow excitation focusing lens, such that the excitation beam forms a line through the sample. This has the added advantage of making alignment generally easier.

Beam drift introduced by waveplate rotation can be mitigated by performing measurements with more than the minimum of two waveplate orientations. For CPL measurements, a total of four different orientations can be used, and for linear polarization measurements eight orientations are possible. Using multiple orientations helps due to the beam drift being at least partially reversed upon further rotation of the waveplate (as rotation by 360° should return the beam to its initial position).

A further automatable approach to mitigate pixel sensitivity is the scanning multichannel approach. Here, instead of doing a single series of accumulations at a given grating position, a smaller number of accumulations is performed at multiple slightly offset grating positions. As an added benefit, this will similarly smooth out any larger-scale sensitivity variations of the intensifier/detector, which normally have slightly lower sensitivity near the edge regions, without requiring a manual calibration file.

Slit width introduces s a tradeoff between intensity and resolution. For a narrow-line emission like that of Eu³⁺, narrow (10-50 μm) slit widths can be used to avoid smearing out features. For a pixel array detector, the pixel size usually introduces the lower limit to which slit size can improve resolution. Finer gratings allow for greater resolution at the cost of narrower bandpass (and, for holographic gratings, greater polarization sensitivity). For broader spectral shapes, such as the organic molecules investigated herein, a wider (100-200 μm) slit allows for more light incoupling and is therefore advantageous.

A flow cell may be appropriate for sensitive applications, in particular, if sample degradation is an issue.

To obtain the static stokes vector, six measurements are to be executed in total. First, the measurement of S₁ is carried out with the QWP fixed at 0°, while the HWP is set to 0° and 45°. Second, the measurement of S₂ is performed with the QWP at 0°, and the HWP rotated to 22.5° and 67.5°. Third, the S₃ (=gₗᵤₘ*S₀) is performed with the HWP set at an arbitrary angle, along with the QWP orientations at 45° and −45°. Executing these measurements effectively switches the polarization tracks and minimizes the contributions from other polarizations, achieving the desired results. To extend the steady-state Stokes vector with time resolution, additionally, each of the six measurements are performed at different time steps. These time steps are defined in terms of gate width and delay.

### Example Measurements

In the following, example measurements using an embodiment of a luminescence spectroscopy apparatus are described.

### Chiral Lanthanide Complex

### Steady State and Microsecond Gating of Eu[(+)-Facam]₃

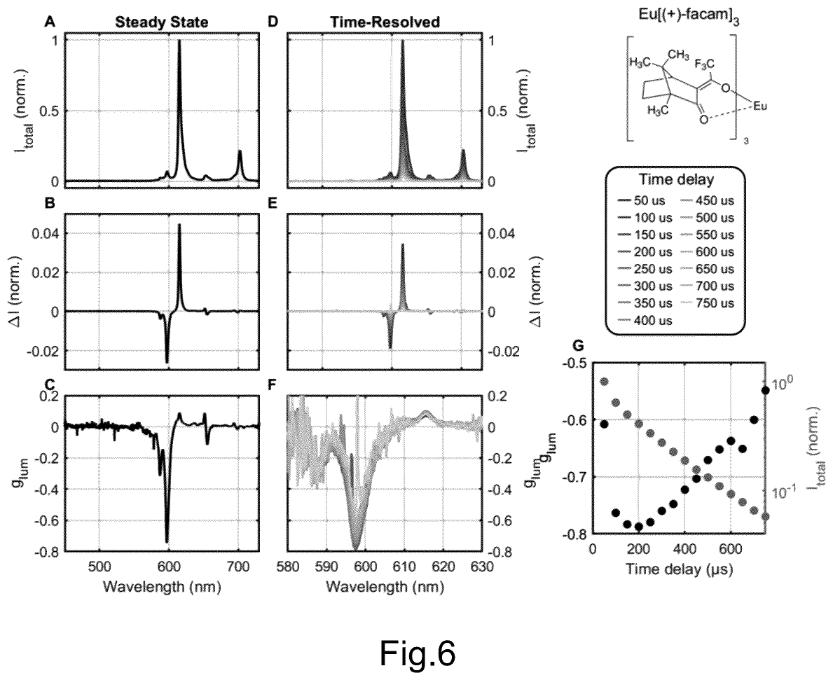

Organometallic lanthanide complexes with chiral ligands are standard materials for strong CPL activity. In particular, Eu[(+)-facam]₃ ((+)-facam=3-(trifluoromethylhydroxymethylene)-(+)-camphorate) possesses strong emission dissymmetry (up to gₗᵤₘ=−0.78 in DMSO at λ=595 nm). Thus, Eu[(+)-facam]₃ is a common choice for CPL setup validation. Accordingly, first steady-state and long timescale time-resolved (50 μs gate width) CPL spectra of Eu[(+)-facam]₃ in dry DMSO are presented, as seen in FIG. 6. The features seen arise from f-f transitions on the Eu³⁺ center, which generally are of the form ⁵D_{J1→}⁷F_{J2}, more specifically here the features are assigned to ⁵D_{0→}⁷F_{J2} transitions. Of these, the most striking CPL features are at 595 nm and 613 nm, respectively corresponding to an ⁵D_{0→}⁷F₁ magnetic dipole transition and ⁵D_{0→}⁷F₂ induced electric dipole transition, with literature gₗᵤₘ=−0.78 and +0.072, respectively (albeit with some variance and environmental sensitivity, notably to water). In the steady state, our results match literature well. Time-resolved spectra (FIG. 6D-F) show little spectral shape evolution over time, but the measured gₗᵤₘ varies with time across the decay (FIG. 6G). The reduction in gₗᵤₘ over time is similar to what was observed before, where a decrease from a peak value of approximately −0.8 with a time constant of approximately 1 ms is reported and assigned to sample heterogeneity. Intriguingly, the data appears to show an increase in gₗᵤₘ over time for approximately the first 150 μs; while the earliest data point in FIG. 6G may contain an element of instrument response, the rise continues beyond this. Therefore, both in the steady state and long timescale time-resolved measurements, the setup gives results consistent with previous literature for Eu[(+)-facam]₃. FIG. 6A shows total steady-state luminescence intensity (405 nm CW excitation), summed across all measurements. FIG. 6B shows steady-state luminescence intensity difference, representing excess counts of a given handedness, normalized by the maximum total luminescence intensity. FIG. 6C shows the steady-state dissymmetry factor gₗᵤₘ. FIG. 6D shows Total time-resolved luminescence spectra (343 nm excitation, 200 fs pulses at 1 kHz), normalized to the earliest time delay, 50 μs bins. FIG. 6E shows time-resolved difference counts, normalized to the earliest bin. FIG. 6F shows the time-resolved dissymmetry factor. FIG. 6G shows intensity and dissymmetry factors as a function of time in a 0.3 nm range around the dissymmetry minimum.

### Nanosecond Gating of Eu[(+)-Facam]₃

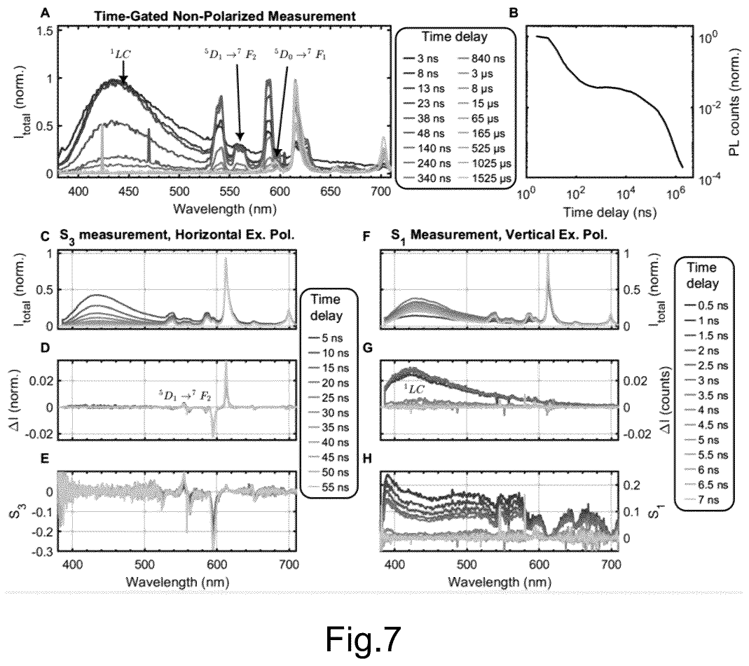

Having shown measurement for the steady-state and long timescale TRCPL of Eu[(+)-facam]₃, short timescale TRCPL with 2-5 ns gating is shown in FIG. 7, being the first such results collected. FIG. 7A shows non-polarization sensitive luminescence spectra (excitation 343 nm, 200 fs, 500 Hz) with varying time bins spanning different luminescence regimes of Eu(facam)₃, normalized to highlight spectral changes. Key transitions around 400-500 nm (¹LC), 550 nm (⁵D_{1→}⁷F₂) and 595 nm (⁵D_{0→}⁷F₁) are labelled. FIG. 7B shows non-polarization sensitive PL decay kinetic, integrated over the emission time-resolved CPL measurement spectrum. FIGS. 7C-E show (excitation 343 nm, 200 fs, 50 kHz, horizontal polarization) with 5 ns bins, using horizontal excitation polarization to avoid photoselection. FIGS. 7F-H show time-resolved horizontal/vertical linear polarization measurement (excitation 343 nm, 200 fs, 50 kHz, vertical polarization) with 2 ns bins and 0.5 ns steps, using vertical excitation polarization to intentionally induce photoselection.

Overall time-resolved spectra at various timescales are plotted in FIG. 7A), with a PL kinetic shown in FIG. 7B. Compared to steady state and long timescale spectra, a number of features besides the ⁵D_{0→}⁷F_{J2} transitions are visible at early times, most obviously a broad, structureless peak around 435 nm and a series of narrower peaks in the 520-570 nm range.

For interpreting these additional features in the early-time Eu[(+)-facam]₃ spectra, it is useful to refer to the spectra of Eu³⁺ more generally. Eu³⁺ has a multitude of well-studied spectral lines arising from ⁵D_{J1→}⁷F_{J2} transitions. As these are weakly absorbing (being weak magnetic dipole transitions or Laporte forbidden electric dipole transitions), PL intensity can be greatly enhanced by exciting symmetry-allowed electric dipole transitions involving a ligand. The ligands effectively act as antennae, transferring energy to the Eu³⁺ center from which subsequent emission occurs. The initially excited transition is the ligand singlet ¹LC, and energy transfer to Eu³⁺ occurs from the ligand spin-triplet ³LC state. Therefore, intersystem crossing (ISC) must occur, with incomplete ISC or energy transfer resulting in ligand-centered emission. Energy transfer occurs preferentially via the ⁵D₁ level, per the selection rules for Dexter transfer. Emission from ⁵D₁, ⁵D₂ and even ⁵D₃ is occasionally observed, particularly in inorganic host lattices, which are associated with a much shorter decay time than the main ⁵D₀ emission. The features observed are consistent with such a mechanism, exhibiting a broad unstructured ligand-centered fluorescence within the first ca. 50 ns, followed by ⁵D_{1→}⁷F_{J2} emission lines up to approximately 200 ns, and finally the long-lived ⁵D_{0→}⁷F_{J2} lines which comprise the main emission overwhelmingly dominating steady-state spectra. In particular, it is noted that the ⁵D_{1→}⁷F₂ transition around 555 nm is a magnetic dipole transition, similar to the strongly dissymmetric ⁵D_{0→}⁷F₁ transition around 595 nm.

To find whether these short-lived features exhibit CPL activity, a CPL measurement is performed with 5 ns gate steps and width (FIG. 7C-E). For minimizing photoselection effects, a horizontal excitation polarization was used. Both ligand-centered (¹LC) and ⁵D_{1→}⁷Fₙ transitions are clearly observed. The ligand-centered transition does not appear to be CPL-active; even if some dissymmetry were present, one may expect this to be far smaller than that of Eu³⁺ transitions and within the noise level of this measurement. In contrast, ⁵D_{1→}⁷_{F}n transitions possess significant anisotropy, in particular the ⁵D_{1→}⁷F₂ transition at 555 nm has a bisignate CPL peak with |gₗᵤₘ|˜0.2.

For demonstration purposes, photoselection is intentionally induced by vertically polarized excitation and an S₁ linear polarization measurement performed with 2 ns gate width and 0.5 ns gate steps, resulting in oversampled (partially overlapping) time bins (FIGS. 7F-H). As might be expected, some linear polarization is present in the ¹LC emission, which almost completely disappears within instrument response (around 2 ns, mainly limited by gate width). Though Eu³⁺ emission is observed, these features exhibit far less linear polarization, since these ionic transitions are from states populated only after ligand excitation and energy transfer. This implies that even when intentionally maximized, significant linear polarization is not present on timescales used for the CPL measurements in FIGS. 7C-E.

Nanosecond time resolution therefore allows to clearly resolve several transitions which were not observable before even in one of the most characterized CPL complexes, as they were drowned out by the long-lived main emission in steady-state and microsecond time-resolved measurements.

### Chiral Organic Delayed Fluorescence Emitter

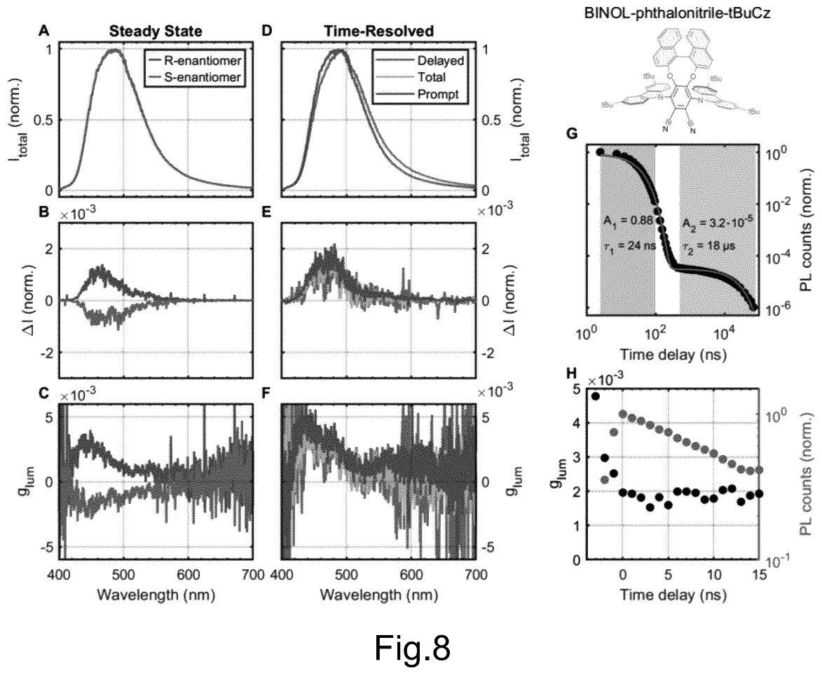

While strongly CPL-active chiral lanthanide complexes provide a convenient benchmark, studies on chiral emitters often involve materials with much weaker dissymmetry and faster luminescence. For example, purely organic small molecules in solution rarely exceed gₗᵤₘ=10⁻³−10⁻² even in best-performing materials. Accordingly, a broader applicability with a CPL-active organic molecule is demonstrated. To introduce multiple timescales of emission, a recently developed chiral organic thermally activated delayed fluorescence (TADE) molecule is selected which has been previously characterized for CPL in the steady state. The molecular structure of this compound, here called (R/S)-BINOL-phthalonitrile-tBuCz, is shown in FIG. 8. Temporal characterization of CPL for this material, which combines ns-scale and μs-scale decay with gₗᵤₘ of order 10⁻³, is not feasible with pre-existing TRCPL W (methods.

FIGS. 8A-C show CPL spectra of R- and S-enantiomers (excitation 343 nm, 200 fs, 12.5 kHz). FIGS. 8D-F show time-resolved CPL spectra of the R-enantiomer. ‘Prompt’ refers to the first 100 ns, ‘Delayed’ to approximately 500 ns-80 μs, and ‘Total’ to a gate covering the complete emission process. FIG. 8G shows the total intensity decay kinetic (integrated over the full spectrum), with highlighted regions showing the ‘Prompt’ and ‘Delayed’ time regions and fitted constants for biexponential decay. FIG. 8H shows the dissymmetry factor (average from 445-455 nm) and total intensity decay (sum over 400-450 nm) kinetic as a function of time with 3 ns bins and 1 ns steps for the S-enantiomer (50 kHz repetition rate).

The two enantiomers show mirror-image steady-state CPL spectra (FIG. 8A-C) as expected, and the obtained gₗᵤₘ values of +1.8×10⁻³ and −1.3×10⁻³ at peak emission wavelength for the R and S enantiomers, respectively, match well the reported gₗᵤₘ value of 1.6×10⁻³ for this material. To introduce time resolution, two experiments are performed on R-BINOL-phthalonitrile-tBuCz. First, the prompt is separately gated, delayed and total emission components (FIG. 8D-F). The total emission kinetic (FIG. 8G) clearly displays a biexponential emission process; the time ranges used for prompt and delayed emission are shown by the shaded regions, whereas the time gate for the total emission covers the entire emission timescale. Compared to the delayed component, prompt emission is approximately 1000 times shorter-lived, but over 10000 times intense. Accordingly, the total emission is dominated by the prompt component, such that the prompt and total emission spectra in FIG. 8D completely overlap. Somewhat unexpectedly, there appears to be a slight spectral shift between the prompt and delayed components; the emitting state in TADF is expected to be ¹CT for both cases, so the spectra should be identical. In principle, this could arise from delayed fluorescence overlapping phosphorescence from either the ³CT state or a ³LE localized triplet, or other long-lived species, although usually phosphorescence is not observed at room temperature for a purely organic molecule in solution at room temperature. Regardless of this slight spectral shift, the dissymmetry of the delayed component is not significantly altered, and the CPL/gₗᵤₘ spectra (FIG. 8E/F) are indistinguishable within noise for the different time bins. This confirms that not only is the instrument sensitive enough to accurately quantify gₗᵤₘ on the order of 10⁻³, but it can also do so for a temporally separated emission component comprising only about 1% of the total emission intensity.

Finally, for demonstrating higher time resolution for even low CPL dissymmetry, CPL data has been collected with 3 ns bins and 1 ns steps (FIG. 8H). As the bin size exceeds the time steps, one gets a rise from instrument response for the first few bins. As convolution and division are not commutative, dissymmetry factors within instrument response should not be interpreted. Yet, after instrument response, gₗᵤₘ remains constant over the measured 15 ns time range where prompt decay is observed. This demonstrates that ns tracking of gₗᵤₘ on the order of 10⁻³ is feasible with the setup and concludes the first transient CPL characterization of a chiral TADE compound.

### Discerning Polarization Artefacts and Relaxation in an Achiral Dye

An achiral standard dye (rhodamine B in water, used also widely as fluorescent staining agent in biology) is measured to demonstrate i) low-noise zero baseline when photoselection is minimized, ii) presence & time-evolution of various apparent polarization components when photoselection is induced, and iii) full Stokes vector ns time evolution.

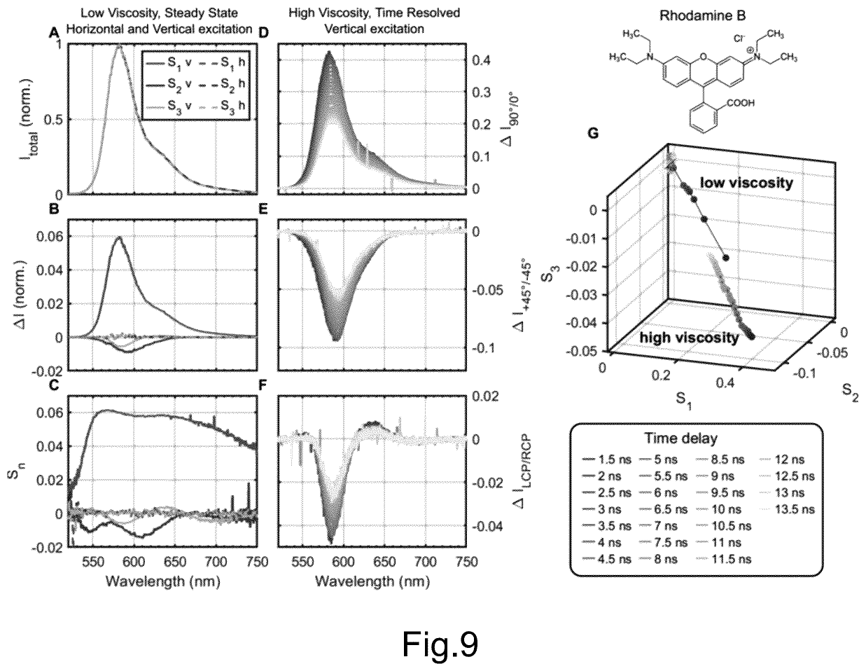

First, steady-state results are presented in a relatively low-viscosity aqueous solution with horizontal excitation polarization to minimize photoselection effects and vertical excitation polarization to intentionally maximize photoselection effects. FIGS. 9A-C show steady-state Stokes-vector measurements (excitation 515 nm, 200 fs, 50 kHz) in a low-viscosity and environment with horizontal and vertical excitation polarizations to inhibit and induce photoselection effects, respectively. Vertical excitation polarizations to solid correspond lines, horizontal excitation polarizations to dashed lines. It is pointed out that all spectra overlap in FIGS. 9A, and in 9B and 9C, the dashed lines are all flat around 0. FIGS. 9D-F show time resolved intensity differences (excitation 515 nm, 200 fs, 50 kHz) over the Stokes polarization basis (normalized to total intensity maximum) in a high-viscosity environment with vertical excitation polarization to induce photoselection. FIG. 9G shows the time evolution of all Stokes components (averaged over a 10 nm range around the emission peak) in low-viscosity and high-viscosity environments with vertical excitation polarization (2 ns time bins, 0.5 ns time steps), mapping distinctly different depolarization pathways over time. Due to the time bins exceeding the time steps, earliest bins are within instrument response.

The overall emission spectrum is not impacted by excitation polarization (FIG. 9A) and with horizontally polarized excitation we observe a flat background around 0 with noise at or below 10⁻³ for all Stokes vector components, as expected for an achiral small molecule in solution (FIG. 9B/C, dashed lines). When vertically polarized excitation is used, nonzero values for all polarization components are observed (FIG. 9B/C, solid lines). Expectedly, the S₁ component (horizontal-vertical linear polarization) shows the greatest response. Small but nonzero S₂ values might stem from an excitation beam which is slightly tilted (so the excitation polarization is not perfectly vertical in the detection axis), while a nonzero S₃ component for an achiral sample represents a CPL artifact. Such artifacts are well known to plague CPL measurements generally including the two-channel CCD approach and can be attributed to imperfections in the optical properties of components, such as residual birefringence and dichroism.

For the purposes of the time-resolved CPL measurement, it is desired to explicitly quantify how time-evolving real linear polarization impacts resultant CPL artifacts over time. This requires the presence of time-evolving linear polarization on sufficiently long timescales to be properly characterized by the instrument. In solution, molecules can rotate to reorient themselves, and therefore any preferential orientation of excited molecules arising from polarization of the excitation light is lost over time. While this is a straightforward way to achieve time-evolving linear polarization of emission, in many solvents the rotational relaxation timescale for fluorophores are faster than the ˜2 ns instrument response of the present example setup, but can be increased through solvent viscosity. As the emission properties of Rhodamine B are somewhat environment-dependent, rather than selecting completely different solvents of low and high viscosity it was decided to use water as a relatively low-viscosity environment and to increase the viscosity by adding sucrose. In a high-viscosity environment with vertically polarized excitation to induce photoselection, a very S₁ large component is present immediately after excitation (FIG. 9D), with emission becoming depolarized over time. Smaller S₂ and S₃ components are also measured and depolarized over time (FIG. 9E, F), with their shape and magnitude (relative to S₁) consistent with the steady-state measurements in a low-viscosity medium (FIG. 9B).

The time evolution of Stokes parameters around the emission maximum in low and high-viscosity solutions are plotted in FIG. 9G. For the low-viscosity solution, depolarization occurs almost completely within instrument response and the Stokes parameters are clustered around 0. For the high-viscosity solution emission remains partially polarized even after 10 ns, tracing an approximately straight line through the S₁/S₂/S₃ polarization space. The S₃ component, representing a CPL artifact, is therefore proportional to the real S₁ component (though smaller in magnitude) as expected. These experiments showcase how broadband transient full-Stokes vector tracking enables to effectively discriminate between differently polarized excited state species, and how to distinguish them from artifacts, not captured in a CPL-only detection.

The present setup is therefore capable of time-resolved broadband full Stokes vector luminescence characterization with ns time resolution, ms range and unprecedented gₗᵤₘ sensitivity on the order of 10⁻⁴. Broad applicability of the present setup across various timescales and degrees of CPL activity is demonstrated. For the CPL standard Eu[(+)-facam]₃, literature results could be reproduced in the steady state and for μs-scale time-resolved measurements. By going into the nanosecond regime for the first time, it was possible to separate out and investigate the emission dissymmetry or ligand-centered and higher Eu³⁺ excited states which were hitherto drowned out by the main Eu³⁺ emission channel in steady-state and μs-scale measurements. Moving beyond strong CPL emitters, a chiral TADF molecule was successfully measured with gₗᵤₘ on the order 10⁻³, both by separating out the prompt (ns) and delayed (μs) components and by ns-timescale step-by-step time-evolution. Notably, this first transient CPL characterization of any chiral TADF emitter shows that the dissymmetry of the singlet emission remains unchanged after inter-system crossing and reversal.

An achiral dye was employed to demonstrate a very low-noise baseline, while quantifying linear polarization responses and CPL artifacts in a geometry where excitation polarization induces photoselection of the molecules. By slowing down molecular reorientation and hence depolarization, sensitive transient broadband tracking of all Stokes-vector components was demonstrated on the ns scale, showcasing its power to discriminate between various components and CPL artifacts otherwise missed.

1. A luminescence spectroscopy apparatus for time-resolved characterization of a sample emitting circularly polarized light, comprising a pulsed laser excitation source configured to generate a laser pulse for exciting the sample, an achromatic quarter-wave plate arranged to receive therethrough light emitted by the sample, a polarization beam splitter arranged downstream to the quarter-wave plate, an optical spectrometer arranged downstream to the polarization beam splitter, a time-gated intensified charge-coupled device arranged to receive light from the optical spectrometer and comprising an image intensifier, and a controller configured to control a pulse generator to apply a gate pulse to the image intensifier for selectively activating the image intensifier, wherein the controller is connected to the pulsed laser excitation source such that the gate pulse is triggerable by the laser pulse of the pulsed laser excitation source.

2. The luminescence spectroscopy apparatus according to claim 1, wherein the polarization beam splitter is a birefringent polarization beam splitter.

3. The luminescence spectroscopy apparatus according to claim 2, wherein the birefringent polarization beam splitter is a Wollaston polarizer or a Rochon polarizer.

4. The luminescence spectroscopy apparatus according to claim 1, comprising an achromatic half-wave arranged in sequence with the quarter-wave plate.

5. The luminescence spectroscopy apparatus according to claim 4, wherein the quarter-wave plate is arranged downstream to the half-wave plate.

6. The luminescence spectroscopy apparatus according to claim 1, wherein the charge-coupled device comprises an image area with a first region of interest configured to receive light with a first polarization component and a second region of interest configured to receive light with a second polarization component.

7. The luminescence spectroscopy apparatus according to claim 1, comprising a first motor controller, wherein the quarter-wave plate is rotatably mounted in a motorized rotary mount, wherein the first motor controller is configured to control rotation of the quarter-wave plate.

8. The luminescence spectroscopy apparatus according to claim 1, comprising a second motor controller, wherein the half-wave plate is rotatably mounted in a motorized rotary mount, wherein the second motor controller is configured to control the rotation of the half-wave plate.

9. The luminescence spectroscopy apparatus according to claim 1, wherein the quarter-wave plate and the polarization beam splitter define a detection path downstream of the sample, wherein the pulsed laser excitation source is configured to define an excitation path which is perpendicular to the detection path.

10. The luminescence spectroscopy apparatus according to claim 9, wherein the pulsed laser excitation source is configured to generate a laser pulse having a horizontal polarization.

11. The luminescence spectroscopy apparatus according to claim wherein the quarter-wave plate and the polarization beam splitter define a detection path downstream of the sample, wherein the pulsed laser excitation source is configured to define an excitation path which is parallel to the detection path.

12. A method of time-resolved characterization of a sample emitting circularly polarized light, comprising the steps of:
a) providing a luminescence spectroscopy apparatus according to claim 1;
b) generating by the pulsed laser excitation source a laser pulse for exciting a sample;
c) receiving by the controller a trigger signal from the pulsed laser excitation source;
d) triggering the pulse generator by the controller to generate a gate pulse;
e) activating the image intensifier by applying the gate pulse by the pulse generator to the image intensifier;
f) recording simultaneously a first polarization component of light emitted by the sample on a first region of interest of an image area of the charge-coupled device and a second component of light emitted by the sample on a second region of interest of the image area of the charge-coupled device.

13. The method according to claim 12, comprising the steps of:
executing the steps of b)-f) at a first orientation of the quarter-wave plate with its fast axis being at a first quarter-wave plate angle;
rotating the quarter-wave plate by a first motor controller to a second orientation with the fast axis being at a second quarter-wave plate angle, wherein the first quarter-wave plate angle and the second quarter-wave plate angle differ by 90°;
repeating the steps of b)-e), and
recording the first polarization component of light emitted by the sample on the second region of interest of the image area of the charge-coupled device and the second component of light emitted by the sample on the first region of interest of the image area of the charge-coupled device.

14. The method of claim 13, wherein after rotating the quarter-wave plate by the first motor controller to the second orientation, beam steering is executed on the pulsed laser excitation source until the light from the pulsed laser excitation source is collected by the same pixels of the charge-coupled device as before rotation of the quarter-wave plate.

15. The method according to claim 13, comprising the steps of:
rotating the quarter-wave plate by the first motor controller to a third orientation with the fast axis being at a third quarter-wave plate angle, wherein the second quarter-wave plate angle and the third quarter-wave plate angle differ by 90°;
repeating the steps of b)-f).

16. The method according to claim 15, comprising the steps of:
rotating the quarter-wave plate by the first motor controller to a fourth orientation with the fast axis being at a fourth quarter-wave plate angle, wherein the third quarter-wave plate angle and the fourth quarter-wave plate angle differ by 90°;
repeating the steps of b)-e);
recording the first polarization component of light emitted by the sample on the second region of interest of the image area of the charge-coupled device and the second component of light emitted by the sample on the first region of interest of the image area of the charge-coupled device.

17. The method according to claim 12, comprising the steps of:
providing in step a) an achromatic half-wave plate arranged in sequence with the quarter-wave plate;
executing the steps of b)-f) at a first orientation of the half-wave plate with its fast axis being at a first half-wave plate angle;
rotating the half-wave plate by a second motor controller to a second orientation with the fast axis being at a second half-wave plate angle, wherein the first half-wave plate angle and the second half-wave plate second angle differ by 45°;
repeating the steps of b)-e), and
recording the first polarization component of light emitted by the sample on the second region of interest of the image area of the charge-coupled device and the second component of light emitted by the sample on the first region of interest of the image area of the charge-coupled device.

18. The method of claim 17, wherein after rotating the half-wave plate by the second motor controller to the second orientation, beam steering is executed on the pulsed laser excitation source until the light from the pulsed laser excitation source is collected by the same pixels of the charge-coupled device as before rotation of the half-wave plate.

19. The method according to claim 12, wherein vertical pixel binning is executed in step f) such that only a first track of the first polarization component and a second track of the second polarization component is output from the charge-coupled device.

20. The method according to claim 12, wherein the steps b)-f) are repeated by incrementally changing a position of a grating of the optical spectrometer after each step f).
